(19) United States
(12) Patent Application Publication
(10) Pub. No.: US 2022/0403174 A1
(43) Pub. Date: Dec. 22, 2022

(54) METHOD FOR PREPARING COLORANT HAVING TARGET COLOR AND COLORANT

(71) Applicant: Fudan University, Shanghai (CN)

(72) Inventors: Jiao Chu, Shanghai (CN); Yan Chen, Shanghai (CN); Lei Shi, Shanghai (CN); Xiaohan Liu, Shanghai (CN); Jian Zi, Shanghai (CN)

(21) Appl. No.: 17/842,819

(22) Filed: Jun. 17, 2022

(30) Foreign Application Priority Data
Jun. 18, 2021 (CN) 202110679283.7

(51) Int. Cl. C09B 67/08; C09B 67/06; G01J 3/443

(52) U.S. Cl. CPC C09B 67/0005; C09B 67/0003; G01J 3/443; B82Y 30/00

(57) ABSTRACT

The present disclosure relates to a method for preparing a colorant having a target color and the colorant. The method includes configuring submicron particles prepared from a predetermined material to have a predetermined size; adjusting a ratio of the submicron particles to cuttlefish juice submicron particles to a predetermined ratio; evaporating a predetermined solution mixed with the submicron particles and the cuttlefish juice submicron particles to obtain an amorphous photonic crystal structure; acquiring spectral data for reflected light generated by incident light irradiating the amorphous photonic crystal structure; determining whether the spectral data meets a predetermined condition, wherein the predetermined condition is associated with the target color; and responsive to determining that the spectral data does not meet the predetermined condition, adjusting at least one of the ratio or a size of each of the submicron particles until the spectral data meets the predetermined condition.

### FIELD

Embodiments of the present disclosure generally relate to preparation of a colorant, and more specifically, to a method for preparing a colorant having a target color, and a colorant having a target color.

### BACKGROUND

Legacy colorants (for example, but not limited to, edible colorants) are generally divided into two types, namely natural colorants and synthetic colorants. The natural colorants are typically sensitive to changes of factors such as light, pH value, temperature and the like. As such, the coloration of such colorant is not stable, i.e., the color is prone to change or even fade. The organic colorants prepared by the legacy method for preparing synthetic colorants, such as an artificial chemical synthesis method, are mainly formed from aniline dyes separated from coal tar. Although the synthetic colorants are advantageous in well-developed synthesis process, stable coloration and low costs, the artificial chemical synthesis process probably causes environmental pollution. Besides, the synthetic colorants contain components harmful to human. In addition, the natural colorants and the synthetic colorants are limited in color.

Therefore, the legacy solution for preparing a colorant has disadvantages of unstable coloration, and a limited color range. Furthermore, the synthetic colorants contain components harmful to human.

### SUMMARY

According to the present disclosure, there is provided a method for preparing a colorant having a target color, and a colorant, to improve the coloration stability and fulfil free adjustment to color.

In accordance to a first aspect of the present disclosure, there is provided a method for preparing a colorant having a target color. The method includes: configuring submicron particles prepared from a predetermined material to have a predetermined size, wherein the predetermined size associated with a predetermined hue; adjusting a ratio of the submicron particles prepared from the predetermined material to cuttlefish juice submicron particles to a predetermined ratio, wherein the predetermined ratio is associated with a predetermined color saturation; evaporating a predetermined solution mixed with the submicron particles prepared from the predetermined material and the cuttlefish juice submicron particles such that the submicron particles prepared from the predetermined material and the cuttlefish juice submicron particles can be self-assembled into an amorphous photonic crystal structure; acquiring spectral data for reflected light generated by incident light irradiating the amorphous photonic crystal structure; determining whether the spectral data meets a predetermined condition, wherein the predetermined condition is associated with the target color; and responsive to determining that the spectral data does not meet the predetermined condition, adjusting at least one of the ratio or a size of each of the submicron particles prepared from the predetermined material, until the spectral data meets the predetermined condition to generate the colorant having the target color based on the amorphous photonic crystal structure.

In accordance with a second aspect of the present disclosure, there is provided a colorant that is prepared with the method according to the first aspect of the present disclosure.

In some embodiments, responsive to determining that the spectral data do not meet the predetermined condition, adjusting at least one of the ratio or the size of each of the submicron particles prepared from the predetermined material comprises: responsive to determining that a difference between a color saturation indicated by the spectral data and a saturation threshold of the target color is greater than or equal to a first threshold, adjusting the ratio of the submicron particles prepared from the predetermined material to the cuttlefish juice submicron particles; responsive to determining a difference between a color saturation indicated by the spectral data and a saturation threshold of the target color is less than the first threshold, determining whether a difference between a hue indicated by the spectral data and a hue threshold of the target color is greater than or equal to a second threshold; responsive to determining that the hue indicated by the spectral data and the hue threshold of the target color is greater than or equal to the second threshold, adjusting the size of each of the submicron particles prepared from the predetermined material; and responsive to determining the difference between the hue indicted by the spectral data and the hue threshold of the target color is less than the second threshold, determining that the spectral data meets the predetermined condition.

In some embodiments, responsive to determining that the hue indicated by the spectral data and the hue threshold of the target color is greater than or equal to the second threshold, adjusting the size of the submicron particles prepared from the predetermined material comprises: responsive to determining that the difference between the hue indicated by the spectral data and the hue threshold of the target color is greater than or equal to a third threshold, adjusting an inner diameter of each of hollow nanosphere shells of the submicron particles prepared from the predetermined material; and responsive to determining that the difference between the hue indicated by the spectral data and the hue threshold of the target color is greater than or equal to the second threshold and less than the third threshold, adjusting a layer thickness of each of the hollow nanosphere shells of the submicron particles prepared from the predetermined material.

In some embodiments, the nanosphere shells of the submicron particles prepared from the predetermined material each have an inner diameter between 170 nm and 250 nm and a layer thickness between 20 nm and 50 nm, and the predetermined material is an edible material.

In some embodiments, the predetermined material is titanium dioxide or silicon dioxide, the submicron particles prepared from the predetermined material are solid or hollow spheres, and the colorant is a food colorant, cosmetic colorant, or pharmaceutical label colorant.

In some embodiments, adjusting the ratio of the submicron particles prepared from the predetermined material to the cuttlefish juice submicron particles to the predetermined ratio comprises: putting the submicron particles prepared form the predetermined material into a predetermined solution to generate a first submicron particle solution; putting the cuttlefish juice submicron particles into the predetermined solution to generate a second submicron particle solution; and adjusting a ratio of the first submicron particle solution to the second submicron particle solution such that the ratio of the submicron particles prepared from the predetermined material to the cuttlefish juice submicron reaches the predetermined ratio.

In some embodiments, evaporating the predetermined solution mixed with the submicron particles prepared from the predetermined material and the cuttlefish juice submicron particles such that the submicron particles prepared from the predetermined material and the cuttlefish juice submicron particles can be self-assembled into the amorphous photonic crystal structure, comprises: applying to a target object the predetermined solution mixed with the submicron particles prepared from the predetermined material and the cuttlefish juice submicron particles; baking or freezing the target object to evaporate or sublimate the predetermined solution such that the submicron particles prepared from the predetermined material and the cuttlefish juice submicron particles can be self-assembled into the amorphous photonic crystal structure on the target object, wherein a baking temperature is less than or equal to 250° C.

In some embodiments, evaporating the predetermined solution mixed with the submicron particles prepared from the predetermined material and the cuttlefish juice submicron particles such that the submicron particles prepared from the predetermined material and the cuttlefish juice submicron particles can be self-assembled into the amorphous photonic crystal structure, comprises: leaving the predetermined solution mixed with the submicron particles prepared from the predetermined material and the cuttlefish juice submicron particles to stand, the predetermined solution being water; and evaporating the predetermined solution such that the submicron particles prepared from the predetermined material and the cuttlefish juice submicron particles can be self-assembled into the amorphous photonic crystal structure.

The summary is provided to introduce the selection of the concepts in a simplified form, which will be further described below in the detailed description of embodiments. This summary is not intended to identify key features or essential features of the present disclosure as described herein, nor is it intended to be used to limit the scope of the present disclosure.

### BRIEF DESCRIPTION OF THE DRAWINGS

FIG. 1 is a flowchart of a method for preparing a colorant having a target color according to embodiments of the present disclosure.

FIG. 2 is a schematic diagram illustrating submicron particles prepared from a predetermined material according to embodiments of the present disclosure.

FIG. 3 is a schematic diagram illustrating an amorphous photonic crystal structure according to embodiments of the present disclosure.

FIG. 4 is a schematic diagram illustrating spectral data of an amorphous photonic crystal structure sample according to embodiments of the present disclosure.

FIG. 5 illustrates coloration data of an amorphous photonic crystal structure sample according to embodiments of the present disclosure.

FIG. 6 illustrates qualitative test data for cell viability of a colorant according to embodiments of the present disclosure.

FIG. 7 illustrates quantitative test data for cell viability of a colorant according to embodiments of the present disclosure.

FIG. 8 illustrates test data for bioavailability of a colorant according to embodiments of the present disclosure.

FIG. 9 is a flowchart of a method for adjusting a size of each of submicron particles prepared from a predetermined material according to embodiments of the present disclosure.

FIG. 10 is a flowchart illustrating a method for adjusting the ratio or a size of each of submicron particles prepared from a predetermined material according to embodiments of the present disclosure.

FIG. 11 is a flowchart of a method for adjusting a ratio to a predetermined ratio according to embodiments of the present disclosure.

FIG. 12 illustrates cream cakes decorated with edible structural colorants based on an amorphous photonic crystal structure according to embodiments of the present disclosure.

Throughout the drawings, the same or similar reference symbols refer to the same or similar components.

### DETAILED DESCRIPTION OF EMBODIMENTS

Reference now will be made to the accompanied drawings to describe preferred embodiments of the present disclosure in more detail. Although the drawings illustrate preferred embodiments of the present disclosure, it would be appreciated that the present disclosure could be implemented in various forms, not restricted to those described here. Rather, those embodiments are provided to make the present disclosure more thorough and complete and enable the scope of the present disclosure to be fully conveyed to those skilled in the art.

As used herein, the term “includes” and its variants are to be read as open terms that mean “includes, but is not limited to.” Unless indicated otherwise, the term “or” is to be read as “and/or”. The term “based on” is to be read as “based at least partly on.” The terms “an example embodiment” and “an example” are to be read as “at least one example embodiment.” The term “another embodiment” is to be read as “at least one another embodiment.” The term “first,” “second,” or the like may refer to different objects or the same object.

As described above, the legacy solution for preparing a colorant has disadvantages of unstable coloration, and a limited color range. In addition, synthetic colorants contain components harmful to human.

In order to at least partly solve the above problem and one or more other potential problems, there is provided a solution for preparing a colorant having a target color according to example embodiments of the present disclosure. According to the solution, an amorphous photonic crystal structure can be created by mixing cuttlefish juice submicron particles and submicron particles of a predetermined material, and utilizing a self-assembly effect of the two types of submicron particles. As such, the present disclosure can generate a structural colorant. In addition, adjustment of a hue and saturation of the target color can be implemented in the following way: comparing spectral data for reflected light of the amorphous photonic crystal structure with a predetermined condition (the predetermined condition is associated with the target color), and adjusting a size of each of the submicron particles of the predetermined material and a relative ratio between the two types of submicron particles when the spectral data does not meet the predetermined condition. In this way, the present disclosure can improve the coloration stability and fulfil free adjustment to the color.

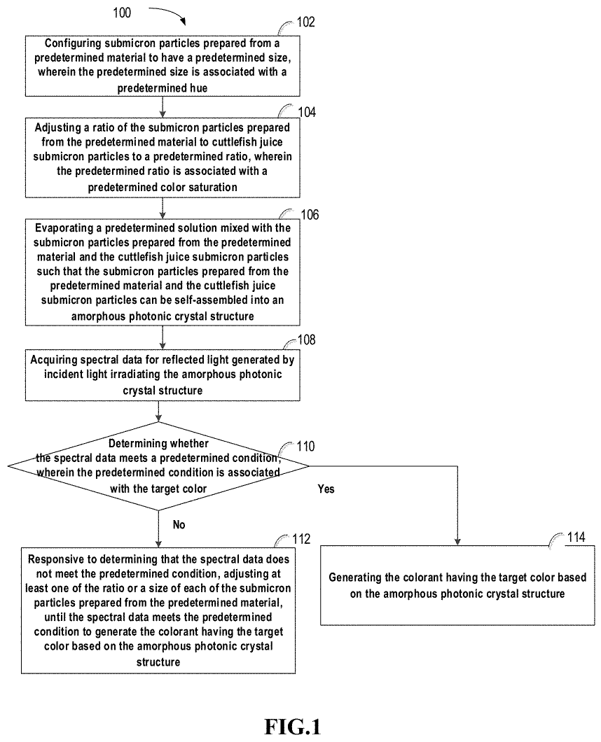

Reference below will be made to FIG. 1 to describe a method 100 for preparing a colorant having a target color according to embodiments of the present disclosure. FIG. 1 is a flowchart of a method for preparing a colorant having a target color according to embodiments of the present disclosure. It would be appreciated that the method 100 may include additional actions not shown and/or skip some actions shown therein, and the scope of the present disclosure is not limited in the aspect.

At block 102, submicron particles prepared from a predetermined material are configured to have a predetermined size that is associated with a predetermined hue.

The predetermined material, for example, may be an edible material. In some embodiments, the predetermined material is, for example, titanium dioxide or silicon dioxide. The submicron particles prepared from the predetermined material may be hollow or solid spheres. It would be appreciated that the submicron particles prepared from the predetermined material may be of submicron structures in other shapes, not limited to hollow or solid spheres. For example, the silicon dioxide submicron particles may be configured to have a radius of 200 nm to 350 nm. Since the titanium dioxide has a large reflective index and the synthesis process of small-sized submicron particles of titanium dioxide is relatively complicated, the submicron particles prepared from titanium dioxide may be configured as hollow submicron particles. By forming the submicron particles prepared from the predetermined material into hollow spheres, the submicron particles can be made larger in size for the same reflective index, thus avoiding food safety issues caused by excessively small-sized submicron particles (for example, less than 100 nanometers). In addition, the size of each hollow submicron particle can be adjusted either by adjusting the inner diameter of the hollow submicron particle, or by adjusting the thickness of the shell of the hollow submicron particle, making it possible to obtain a higher adjustable degree of freedom with respect to the predetermined hue and a larger variety of granularity. In some embodiments, since silicon dioxide has a relatively small reflective index and the synthesis process of the small-sized submicron particles of titanium dioxide is relatively easy, the submicron particles prepared from silicon dioxide may be configured as solid submicron particles. It would be appreciated that the submicron particles prepared from titanium dioxide can also be configured as solid submicron particles. In some embodiments, in addition to titanium dioxide or silicon dioxide, the predetermined material can also be other safe (e.g. edible) material with a reflective index meeting the condition. In some embodiments, the edible titanium dioxide submicron particles (for example, but not limited to, submicron spheres) are mainly from the E171 titanium dioxide food additive, which is typically applied to products, such as desserts, candies, chewing gum, and the like, to enhance the opacity and brightness. Regarding the method for forming submicron particles prepared from a predetermined material, preparation of TiO₂ hollow submicron particles is taken as an example. The submicron particles each having an outer diameter (e.g., 170 nm, 200 nm or 250 nm) are used as a hard template, the outer layer of the hard template then is covered with a TiO₂ shell layer having a thickness, for example, within a range of 20-50 nm, and the hard template is etched thereafter. In this way, TiO₂ hollow submicron particles are prepared.

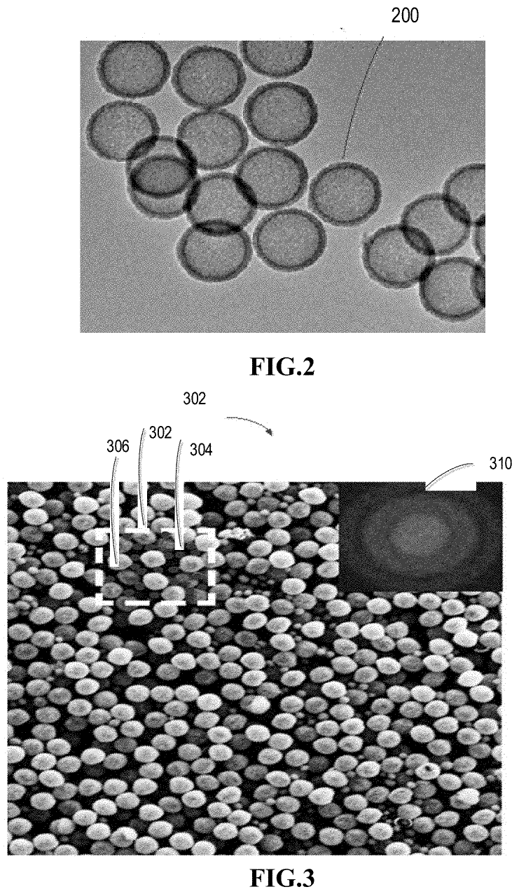

FIG. 2 is a schematic diagram of submicron particles 200 prepared from the predetermined material according to embodiments of the present disclosure. As shown therein, the submicron particles 200 prepared from the predetermined material can be, for example TiO₂ hollow submicron particles. The TiO₂ hollow submicron particles, for example, are prepared with the above-mentioned method that includes covering a hard template and etching away the same. The TiO₂ hollow submicron particle can be, for example, a TiO₂ submicron hollow sphere having an inner diameter of 250 nm and a shell thickness of 37.5 nm.

At block 104, the ratio of the submicron particles prepared from the predetermined material to the cuttlefish juice submicron particles is adjusted to a predetermined ratio which is associated with a predetermined color saturation. By adjusting the ratio of the submicron particles prepared from the predetermined material to the cuttlefish juice submicron particles, the proportion of the cuttlefish juice submicron particles in the amorphous photonic structure can be adjusted, making it possible to control the saturation.

There may be multiple methods for adjusting the ratio of the submicron particles prepared from the predetermined material to the cuttlefish juice submicron particles to a predetermined ratio. In some embodiments, the method of adjusting the ratio between the two submicron particles, for example, includes: mixing the submicron particles prepared from the predetermined material with the cuttlefish juice submicron particles in predetermined proportions (e.g. predetermined mass percentages); putting the mixture of the submicron particles prepared from the predetermined material and the cuttlefish juice submicron particles into a predetermined solution. The predetermined ratio is associated with the predetermined color saturation. In some embodiments, the predetermined solution may be water. In some embodiments may be liquid nitrogen.

In some embodiments, the method for adjusting the ratio between the two types of submicron particles, for example, includes: putting the submicron particles prepared from the predetermined material into a predetermined solution to generate a first submicron particle solution; then putting the cuttlefish juice submicron particles into a predetermined solution to generate a second submicron particle solution; and adjusting a ratio of the first submicron particle solution to the second submicron particle solution, causing the ratio of the submicron particles prepared from the predetermined material to the cuttlefish juice submicron particles to reach the predetermined proportion. For example, a 5% first submicron particle solution (i.e., the submicron particles prepared from the predetermined material occupies a mass percentage of 5% of the first submicron particle solution) and a 0.5% second submicron particle solution (i.e., the cuttlefish juice submicron particles occupies a mass percentage of 0.5% of the second submicron particle solution) are mixed in a ratio of 1:1. The ratio of the submicron particles prepared from the predetermined material to the cuttlefish juice submicron particles reaches a predetermined ratio, i.e., 10:1.

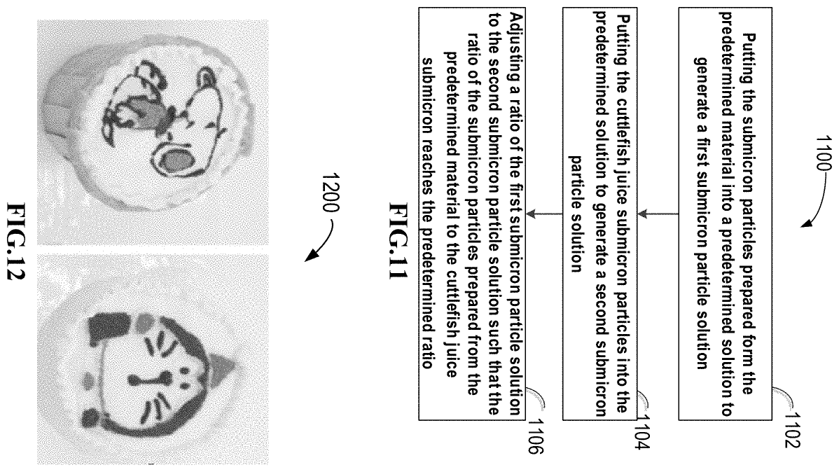

Reference below will be made to FIG. 11 to describe a further method for adjusting the ratio between two types of submicron particles, which is omitted here for brevity.

At block 106, the predetermined solution mixed with the submicron particles prepared from the predetermined material and the cuttlefish juice submicron particles is evaporated such that the submicron particles prepared from the predetermined material and the cuttlefish juice submicron particles can be self-assembled into an amorphous photonic crystal structure.

The self-assembling process according to the present disclosure refers to that basic structural units (i.e., the submicron particles prepared from the predetermined material and the cuttlefish juice submicron particles) spontaneously form a short-range ordered structure (as shown in FIG. 3). In the self-assembling process, the basic structural units are spontaneously assembled or aggregated into a stable structure having a regular geometrical appearance as an interaction effect based on non-covalent bonds.

FIG. 3 is a schematic diagram illustrating an amorphous photonic crystal structure 300 according to embodiments of the present disclosure. A Scanning Electron Microscope image (or abbreviated as “a SEM image”) of an amorphous photonic crystal structure is illustrated therein, wherein the amorphous photonic crystal structure is formed by mixing the TiO₂ submicron hollow particles each having an inner diameter of 200 nm and a shell thickness of 40 nm and the cuttlefish juice submicron particles in water, evaporating the water (for example, but not limited to, naturally evaporating the water at room temperature), and self-assembling the TiO₂ submicron particles and cuttlefish juice particles. As shown in FIG. 3, the two types of particles, i.e. the TiO₂ submicron particles and the cuttlefish juice submicron particles, are evenly distributed, which exhibits a satisfactory structural quality. For example, in the dotted block 302, the symbol 306 denotes a TiO₂ hollow submicron particle, and the symbol 304 is a cuttlefish juice submicron particle. The illustration 310 at the upper right corner indicates the 2D Fourier Transform of the SEM image, which reveals the short-range ordered structure of the amorphous structure. The amorphous photonic structure is an important constituent of photonic crystal. It would be appreciated that, since the amorphous photonic crystal structure is only ordered in a short range, non-iridescent coloring can be achieved. Moreover, the amorphous photonic crystal structure self-assembled from the submicron particles prepared from the predetermined material and the cuttlefish juice submicron particles can display a better saturation. This is because that the short-range orderliness of the amorphous photonic structure induces coherent scattering, causing a pseudo-band gap generated in a specific band, and a reflection peak in a respective spectral band. In general, after the black cuttlefish juice submicron particles are introduced, intensive absorption occurs in a wider band. However, since the corresponding density of states at the pseudo-band gap is small, the absorption at the pseudo-band gap is obviously lower than that at other bands. In the case, even though the amorphous photonic structure is provided against a white background, the color thereof still has a satisfied saturation. The coloration of the structure color of the amorphous photonic structure is based on coherent scattering of light, and as long as the structure remains unchanged, the color will not be varied with factors such as temperature, pH value and the like. Therefore, coloration remains stable.

At block 108, spectral data for reflected light generated by incident light irradiating the amorphous photonic crystal structure is acquired. For example, the reflected light generated by incident light irradiating the amorphous photonic crystal structure is acquired through a spectrometer, and the reflectance spectrum is further generated. The reflectance spectrum is transformed into a chroma value in a predetermined color gamut space (e.g. a CIE 1931 color gamut space) through, for example, but not limited to a predetermined algorithm as described below, to attain a respective hue and saturation. In this way, the incident light and the amorphous photonic structure interact with each other, resulting in coherent scattering, and a pseudo-band gap is generated at a specific frequency accordingly. In the case, the spectral data corresponds to a reflection peak at the pseudo-band gap, and the cuttlefish juice submicron particles absorb a board spectrum of light in the visible light band. The density of photon states at the pseudo-band gap is small, where the absorption is obviously less than that at other bands. As such, a structural color with a satisfied saturation can be obtained.

At block 110, it is determined whether the spectral data meets a predetermined condition, wherein the predetermined condition is associated with a target color.

The predetermined condition, for example, includes a saturation threshold of the target color and a hue threshold of the target color. In some embodiments, for example, if it is determined that a difference between the hue indicated by the spectral data and the hue threshold of the target color is less than a second threshold, and a difference between the color saturation indicated by the spectral data and the saturation threshold of the target color is less than a first threshold, it is determined that the spectral data meets the predetermined condition.

The conversion of the spectral data is, for example, performed based on the CIE 1931 color gamut space. Reference below will be made to equations (1) through (6) to describe the method for converting spectral data into a chroma value in a predetermined color gamut space (e.g., a CIE 1931 color gamut space).

$$X = k \sum {{φ}_{λ} ( λ )}^{\overline{x}} ( λ ) Δλ \qquad ( 1 )$$

$$Y = k \sum {{φ}_{λ} ( λ )}^{\overline{y}} ( λ ) Δλ \qquad ( 2 )$$

$$Z = k \sum {{φ}_{λ} ( λ )}^{\overline{z}} ( λ ) Δ λ \qquad ( 3 )$$

$$x = \frac{X}{X + Y + Z} \qquad ( 4 )$$

$$y = \frac{Y}{X + Y + Z} \qquad ( 5 )$$

$$z = \frac{X}{X + Y + Z} \qquad ( 6 )$$

In the equations (1) through (6), k is a normalization constant; φ_{λ}(λ) is measured spectral data for reflected light; x̅_{(λ)}, y̅_{(λ)} and z̅_{(λ)} are CIE1931 color matching functions; Δλ is 1 nm or 5 nm; X, Y and Z are components of the three primary colors (collectively referred to as tristimulus values), which are tristimulus values for a color in the CIE1931 color space.

At block 112, if it is determined that spectral data does not meet predetermined condition, at least one of the ratio and the size of each of the submicron particles prepared from the predetermined material is adjusted, until the spectral data meets predetermined condition to generate a colorant having the target color based on the amorphous photonic crystal structure. If it is determined that the spectral data meets the predetermined condition, the method proceeds to block 114 where a colorant having the target color is generated based on the amorphous photonic crystal structure.

The prepared colorant is, for example, a food colorant, a cosmetic colorant or pharmaceutical label colorant. Titanium oxide and silicon oxide are food additives authorized by FDA (Food and Drug Administration). The cuttlefish juice contains natural black nanoparticles having an average diameter of about 110 nm and comprised of proteoglycans, melanin and the like. Due to the unique nutrients and biological characteristics of the cuttlefish juice, the cuttlefish juice nanoparticles are generally applied to the food and medical field. As such, since the colorant having a target color is prepared by using a amorphous photonic crystal structure formed from the titanium oxide or silicon oxide submicron particles and the cuttlefish juice submicron particles through a self-assembling process as a structural color, the safety of a food colorant, cosmetic colorant or pharmaceutical label colorant that is prepared with the colorant having the target color is guaranteed.

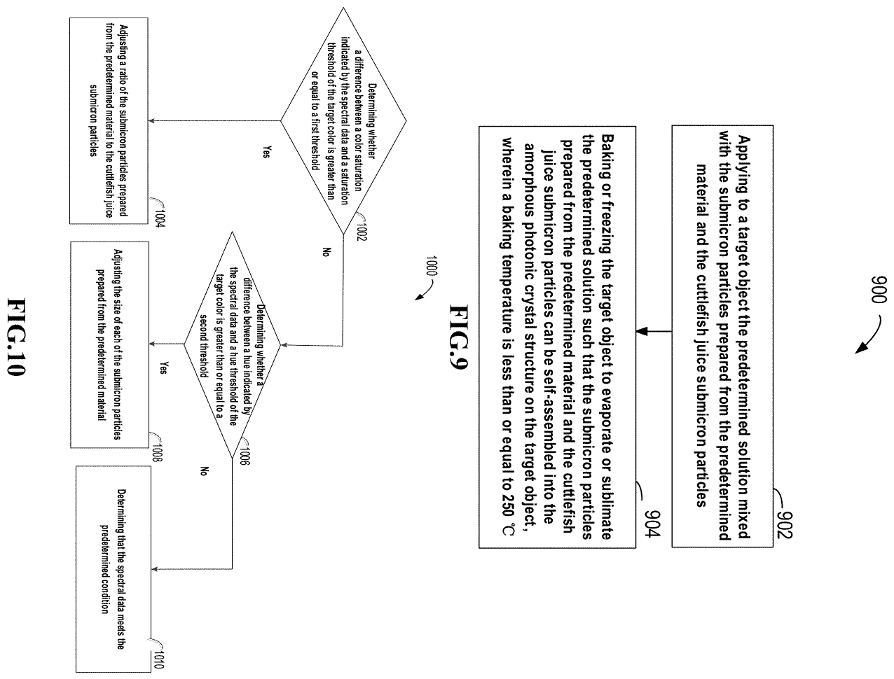

The method for adjusting at least one of the ratio and the size of each of the submicron particles prepared from the predetermined material, for example, includes: determining whether a difference between the color saturation indicated by the spectral data and the saturation threshold is greater than or equal to a first threshold; if it is determined that the difference between the color saturation indicated by the spectral data and the saturation threshold of the target color is greater than or equal to the first threshold, the ratio of the submicron particles prepared from the predetermined material to the cuttlefish juice submicron particles is adjusted; if it is determined that a difference between the color saturation indicated by the spectral data and the saturation threshold of the target color is less than the first threshold, it is determined whether a difference between the hue indicated by the spectral data and the hue threshold of the target color is greater than or equal to a second threshold; if it is determined that the difference between the hue indicated by the spectral data and the hue threshold of the target color is greater than or equal to a second threshold, the size of each of the submicron particles prepared from the predetermined material is adjusted; and if it is determined that the difference between the hue indicated by the spectral data and the hue threshold of the target color is less than the second threshold, it is determined that the spectral data meets the predetermined condition. For example, the inner and outer diameters of the titanium oxide hollow submicron particles and/or the thickness of the sphere shells are adjusted to finely tune the hue. Reference below will be made to FIG. 10 to describe the method for adjusting at least one of the ratio and the size of the submicron particles prepared from the predetermined material, which is omitted here for brevity.

It would be appreciated that the period of the amorphous photonic crystal structure can be changed by adjusting the size of the submicron particles prepared from the predetermined material, such that the frequency corresponding to the pseudo-band gap can be adjusted, making it possible to further adjust the color hue.

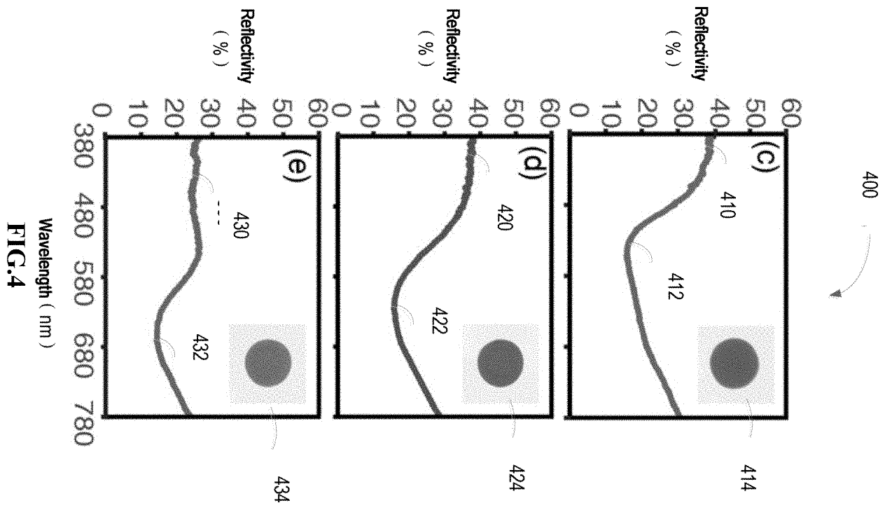

Reference now will be made to FIG. 4 to describe the method for adjusting the color hue by adjusting the size of the submicron particles prepared from the predetermined material. FIG. 4 is a schematic diagram of spectral data 400 of an amorphous photonic crystal structure sample according to embodiments of the present disclosure. The spectral data 400 indicate reflectance spectral data of a self-assembled film generated against a white background based on TiO₂ hollow submicron particles of different diameters. FIG. 4 shows reflectance spectra of three typical colors (namely blue-violet, indigo and cyan from top to bottom).

The symbol 410 denotes a reflectance spectrum of an amorphous photonic crystal structure sample formed by TiO₂ hollow submicron particles with a shell thickness of 30 nm and a hard template size of 170 nm (i.e., the hollow submicron particle has an inner diameter of 170 nm), where the amorphous photonic crystal structure sample has a blue-violet color. The symbol 412 denotes a peak position of the reflectance spectrum 410, and the illustration at the upper right corner of the reflectance spectrum 410 is an optical picture 414 of the blue-violet amorphous photonic crystal structure sample 414. The symbol 420 denotes a reflectance spectrum of an amorphous photonic crystal sample formed by TiO₂ hollow submicron particles with a shell thickness of 30 nm and a hard template size of 200 nm (i.e., the hollow submicron particle has an inner diameter of 200 nm) and cuttlefish juice submicron particles, where the amorphous photonic crystal structure sample has an indigo color. The symbol 422 denotes a peak position of the reflectance spectrum 420, and the illustration at the upper right corner of the reflectance spectrum 420 is an optical picture 424 of the indigo amorphous photonic crystal structure sample. The symbol 430 denotes a reflectance spectrum of an amorphous photonic crystal sample formed by TiO₂ hollow submicron particles with a shell thickness of 30 nm and a hard template size of 250 nm (i.e., the hollow submicron particle has an inner diameter of 250 nm) and cuttlefish juice submicron particles, where the amorphous photonic crystal structure sample has a cyan color. The symbol 432 denotes a peak position of the reflectance spectrum 430, and the illustration at the upper right corner of the reflectance spectrum 430 is an optical picture 434 of the cyan amorphous photonic crystal structure sample. As shown in FIG. 4, with the increase of the size (e.g. the inner diameter) of the submicron particles prepared from the titanium dioxide, the peak position of the spectral data of the amorphous photonic crystal structure sample has an obvious red shift (the peak position is obviously shifted to a longer wavelength), and the reflectance spectra 410 through 430 all show a broad peak. Although the optical picture is captured in a white background, the color of the amorphous photonic crystal structure has a relatively high visibility. The amorphous photonic crystal structure with a broad absorption in the visible spectrum plays a critical role in high color visibility.

In addition, according to the present disclosure, the visible light absorption of the whole system can be changed by adjusting the ratio between the cuttlefish juice submicron particles and the submicron particles prepared from the predetermined material, so as to adjust and control the color saturation.

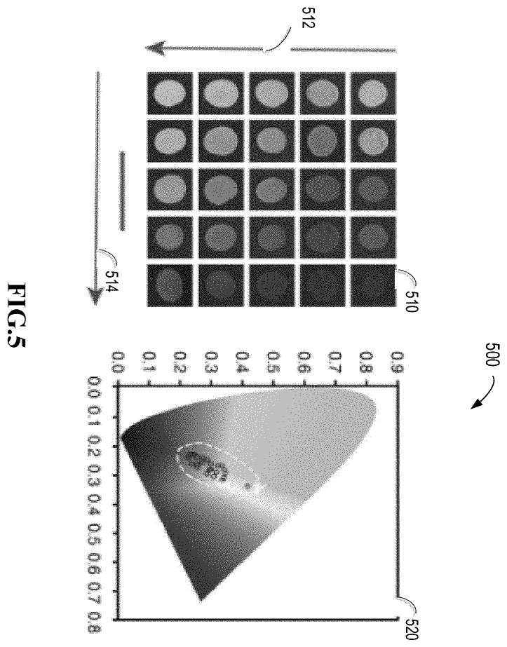

FIG. 5 illustrates coloration data of an amorphous photonic crystal structure sample according to embodiments of the present disclosure. As shown therein, the symbol 510 denotes swatches having a series of blue non-iridescent structural colors obtained by finely tuning the diameter of the SiO₂ submicron particles as a hard template, the layer thickness of the TiO₂ shells and the content (or the proportion) of the cuttlefish juice submicron particles. In FIG. 5, along the direction of the arrow 512, the TiO₂ hollow submicron particles respectively have inner diameters of 170 nm (the first row), 200 nm (the second through fourth rows) and 250 nm (the fifth row) from top to bottom. In addition, the second through fourth rows indicate TiO₂ hollow submicron particles with a fixed inner diameter (200 nm), and the thickness of the shells thus is increased from top to bottom. Meanwhile, along the direction of the arrow 514, the proportion of the cuttlefish juice submicron particles is increased from left to right.

As shown in FIG. 5, by controlling the inner diameter of the TiO₂ hollow submicron particles, the shell thickness and/or the ratio of the cuttlefish juice submicron particles, the present disclosure can adjust the blue non-iridescent structural color. More specifically, the hue can be change significantly by adjusting the inner diameter of the TiO₂ hollow submicron particles. A more subtle change around a certain hue can be made by adjusting the shell thickness of the TiO₂ hollow submicron particles having a fixed inner diameter. Furthermore, the saturation of the structural color can be adjusted by controlling the content (or ratio) of the cuttlefish juice submicron particles. As shown in FIG. 5, a swatch from blue-violet through denim blue to cyan blue displayed in different saturations is obtained ultimately. To enable the color gamut distribution obtained by adjusting the above parameters to be observed more intuitively, a part of the spectral data of the amorphous photonic crystal structure is converted into chroma values of the 1931 CIE. For example, the symbol 520 denotes conversion of the spectrum of the partial amorphous photonic crystal structure sample into the chroma values of the 1931 CIE.

As shown in FIG. 5, the amorphous photonic crystal structure sample has a wide variety in the blue gamut. Therefore, as compared with three legacy edible blue colorants, namely blue 1, blue 2 and phycocyanin, the present disclosure obviously expands the gamut of the edible blue colorant.

In the above solution, by mixing the cuttlefish juice submicron particles and submicron particles of the predetermined material, an amorphous photonic crystal structure is constructed as the self-assembling effect between spheres. In this way, the present disclosure can generate a structural colorant. Coloration of the structural color of the amorphous photonic crystal structure is based on coherent scattering of light, and as long as the structure remains unchanged, the color will not be varied with factors such as temperature, pH value and the like. Therefore, coloration remains stable. In addition, the spectral data for the reflected light of the amorphous photonic crystal structure are compared with a predetermined condition (which is associated with the target color), and when the spectral data do not meet the predetermined condition, adjustment to the target color hue and saturation can be achieved by changing the size of the submicron particles of the predetermined material and the relative proportions of the two types of submicron particles. As such, the present disclosure can improve coloration stability, and achieve free adjustment to color.

In some embodiments, the colorant according to the present disclosure may be a food colorant, a cosmetic colorant or pharmaceutical label colorant. Reference below will made to FIGS. 6-8 to describe a cell viability test performed for the colorant according to the present disclosure and test data of bioavailability of the colorant by simulating the human digestive system.

FIG. 6 shows qualitative test data for cell viability of a colorant according to embodiments of the present disclosure. For the cell viability test performed for the colorant according to the present disclosure, a typical digestive tract Caco-2 cell (a Caco-2 cell is a human cloned colon adenocarcinoma cell, similar to a differentiated intestinal epithelial cell in structure and function, which has features such as microvilli and the like, and contains enzymes related to the brush border epithelium of the small intestine, and can be used in experiment of simulating intestinal transit in vivo. Cellular submicrostructural studies suggest that the Caco-2 cell is morphologically similar to the human intestinal epithelial cell, having the same cell polarity and connections). After a predetermined time (e.g. 24 hours), the activity of Caco-2 cell is observed. The symbol 610 denotes a typical live/dead stained image of the Caco-2 cells exposed to edible structural colorants having gradient concentrations for 24 hours. Symbols 620, 630, 640, 650, 660, 670, 680 and 690 denote positive control groups corresponding to the edible photonic crystal concentrations of 0 μg/ml, 3.1 μg/ml, 6.2 μg/ml, 12.5 μg/ml, 25 μg/ml, 50 μg/ml, 100 μg/ml and 200 μg/m. It can be seen that no obvious Caco-2 cell death was spotted with increasing colorant concentrations of the amorphous photonic crystal structure.

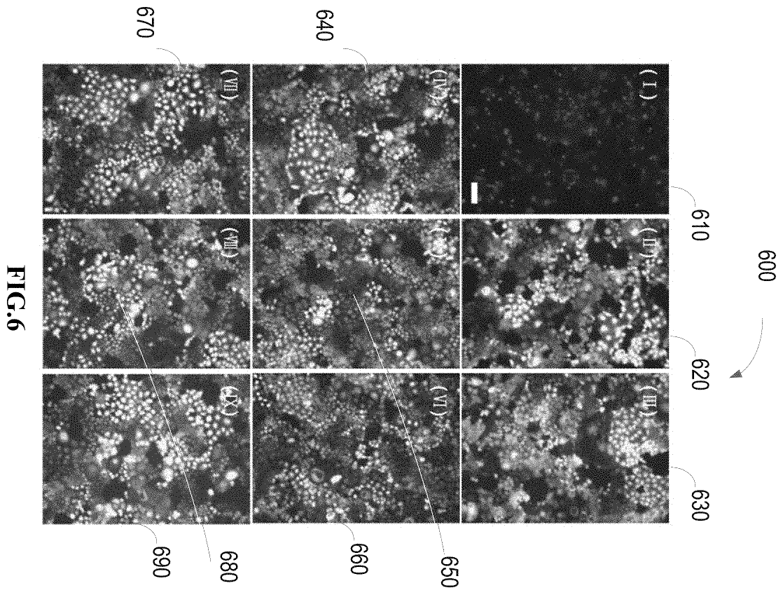

FIG. 7 shows quantitative test data for cell viability of a colorant according to embodiments of the present disclosure. The experiment result demonstrates that the cell viability is greater than 90% in the concentration of 0-200 μg/ml, suggesting that the colorant of the amorphous photonic crystal structure according to the present disclosure is not toxic obviously. According to related investigation data, in the United States, the daily intake of Ti by an adult is 1 mg/kg·b·w if TiO₂ is converted into Ti. Assumed that an adult weighs 75 kg, the daily intake of Ti is 75 g. The daily intake by a child is about 2-4 times greater than the intake by the adult. Assumed that a child weighs 40 kg, the corresponding maximum intake is 160 mg. The human small intestine has an area of 200 m². In the case, the daily exposure to Ti in the small intestine of an adult is about 0.0375 μg/cm², and the daily exposure to Ti in the small intestine of a child is about 0.08 μg/cm². In the cell viability test as shown in FIG. 6, the highest concentration of Ti is set to 125 μg/cm², which is 1563 times greater than the highest concentration of Ti actually exposed to the human. Even in this case, the colorant of the amorphous photonic crystal structure according to the present disclosure shows no obvious toxicity. Therefore, the colorant of the amorphous photonic crystal structure according to the present disclosure can be applied widely in the food field.

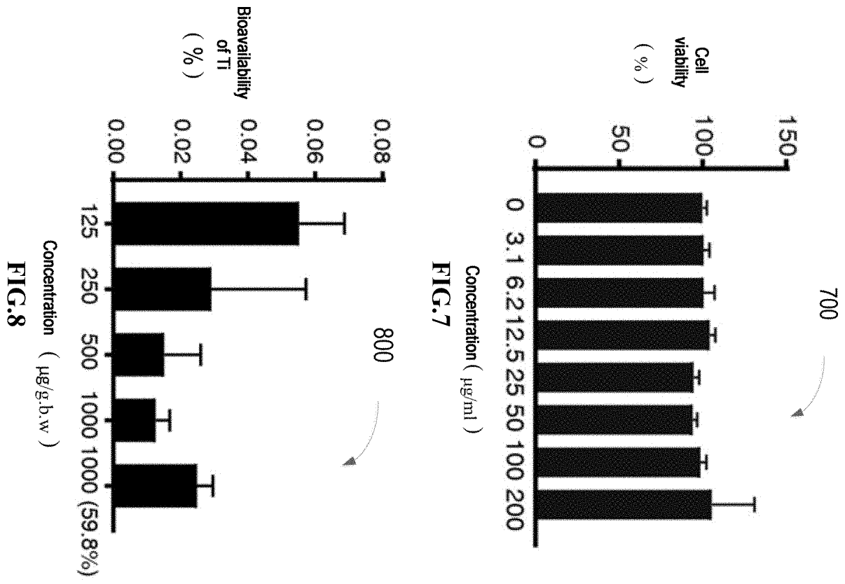

FIG. 8 shows test data for bioavailability of a colorant according to embodiments of the present disclosure. The method for testing the bioavailability, for example, includes: adding the colorant of the amorphous photonic crystal structure with gradient concentrations to a solution of a simulated human digestive system (including a simulated stomach, bile and small intestine) to react with the latter, wherein the highest concentration of Ti in the colorant of the amorphous photonic crystal structure is set to 125 μg/cm², which is 1563 times greater than the highest concentration of Ti actually exposed to the human. The supernatant is taken to detect the content of Ti, and the supernatant detection is thus used to represent an amount of the material absorbed by an organism. In the detection experiment, the maximum bioavailability is 0.06%. The European Food Safety Authority concluded through related tests that, if a bioavailability is 0.06%, the absorption of the material is negligible. The colorant of the amorphous photonic crystal structure according to the present disclosure has a bioavailability of 0.06% less than 1% and thus is safe when used as edible structural colorant.

Reference below will be made to FIG. 9 to describe a method 900 for forming an amorphous photonic crystal structure according to embodiments of the present disclosure. FIG. 9 is a flowchart of the method 900 for adjusting the size of the submicron particles prepared from the predetermined material according to embodiments of the present disclosure. It would be appreciated that the method 900 may include additional actions not shown therein and/or skip some actions shown therein, and the scope of the present disclosure is not limited in the aspect.

At block 902, a predetermined solution mixed with the submicron particles prepared from the predetermined material and the cuttlefish juice submicron particles is applied to a target object. The target object, for example, is food such as, but not limited to, various pastries and candies. For example, a mixture solution of the TiO₂ submicron particles and cuttlefish juice submicron particles are added dropwise onto a surface of a biscuit.

At block 904, the target object is baked or frozen to evaporate or sublimate the predetermined solution such that the submicron particles prepared from the predetermined material and the cuttlefish juice submicron particles can be self-assembled into the amorphous photonic crystal structure on the target object, where the baking temperature is less than or equal to 250° C.

It would be appreciated that, in some embodiments, the target object is naturally evaporated at room temperature such that the submicron particles prepared from the predetermined material and the cuttlefish juice submicron particles can be self-assembled into the amorphous photonic crystal structure on the target object. In some other embodiments, the predetermined solution is sublimated in a frozen condition such that the submicron particles prepared from the predetermined material and the cuttlefish juice submicron particles can also be self-assembled into the amorphous photonic crystal structure on the target object. For example, when an ammonia or fluorine refrigerator is used as a cold source, or a liquid nitrogen quick-freezing technology is used to quickly freeze the target object (e.g. food) at a predetermined temperature below zero, the predetermined solution contained in the target object will be sublimated due to head loss. In the case, the submicron particles prepared from the predetermined material and the cuttlefish juice submicron particles can also be self-assembled into the amorphous photonic crystal structure on the target object.

For example, when baked, the biscuit having drops of the mixture solution added onto the surface is dried with the increasing baking temperature. In the case, the submicron particles prepared from the predetermined material and the cuttlefish juice submicron particles are self-assembled to generate the structural color of the amorphous photonic crystal structure. The structural color is stable in the baked state at a high temperature (130-150° C.), and the legacy phycocyanin will fade at such high temperature. The structural color of the amorphous photonic crystal structure according to the present disclosure can remain stable at the temperature of 250° C. for a long time. In some embodiments, if the heating time is appropriately reduced, the structural color of the amorphous photonic crystal structure according to the present disclosure can be stable at a higher temperature. Due to the above characteristic, the colorant of the amorphous photonic crystal structure formed with the method according to the present disclosure has a wide application in the food field. In addition, after the baked biscuit (including no preservatives) has been stored at room temperature for 1 week, the color of the surface has no obvious change because of the inherent advantage and great stability of the structural color of the amorphous photonic crystal structure.

For example, FIG. 12 shows cream cakes decorated with edible structural colorants based on the amorphous photonic crystal structure according to embodiments of the present disclosure. Edible structural colorants based on the amorphous photonic crystal structure according to the present disclosure can be applied to various desserts and candies, to make them visually attractive to further simulate people's appetite and purchase desire. As shown in FIG. 12, a blue edible structural colorant is applied to a cream cake with a Snoopy pattern and a cream cake with a Doraemon pattern, to fulfil the decoration function.

With the above means, the present disclosure can apply to the surface of the target object a healthy, safe color that is stable in coloration and free from the influence of high temperature. Besides, it would be appreciated that the blue color is a relatively rare natural food color. According to the present disclosure, a blue edible colorant can be generated, which is advantageous in stability, coloring and costs, and can also meet the adjustment requirements in terms of hue and saturation. More importantly, the present disclosure can avoid the harmfulness of artificial chemical synthetic food colorants to the environment and health.

Reference below will be made to FIG. 10 to describe a method 1000 for adjusting the ratio or a size of each of the submicron particles prepared from the predetermined material according to embodiments of the present disclosure. FIG. 10 is a flowchart of a method 1000 for adjusting the ratio or a size of each of the submicron particles prepared from the predetermined material according to embodiments of the present disclosure. It would be appreciated that the method 1000 may include additional actions not shown and/or skip some actions shown therein, and the scope of the present disclosure is not limited in the aspect.

At block 1002, it is determined whether a difference between a color saturation indicated by spectral data and a saturation threshold of a target color is greater than or equal to a first threshold.

At block 1004, if it is determined that the difference between the color saturation indicated by the spectral data and the saturation threshold of the target color is greater than or equal to the first threshold, a ratio of the submicron particles prepared from the predetermined material to the cuttlefish juice submicron particles is adjusted.

At block 1006, if it is determined that the difference between the color saturation indicated by the spectral data and the saturation threshold of the target color is less than the first threshold, it is determined whether a difference between a hue indicated by the spectral data and a hue threshold of the target color is greater than or equal to a second threshold.

At block 1008, if it is determined that the difference between the hue indicated by the spectral data and the hue threshold of the target color is greater than or equal to the second threshold, the size of each of the submicron particles prepared from the predetermined material is adjusted.

The method for adjusting the size of each of the submicron particles prepared from the predetermined material, for example, includes: determining whether the difference between the hue indicated by the spectral data and the hue threshold of the target color is greater than or equal to a third threshold. If the difference between the hue indicated by the spectral data and the hue threshold of the target color is greater than or equal to the third threshold, the inner diameter of each of the hollow submicron particles prepared from the predetermined material is adjusted. If it is determined that the difference between the hue indicated by the spectral data and the hue threshold of the target color is greater than or equal to the second threshold and less than the third threshold, the layer thickness of the shell of each of the hollow submicron particles prepared from the predetermined material is adjusted. Wherein, the third threshold is greater than the second threshold. For example, if the difference between the hue indicated by the current spectral data and the hue of the target color is relatively great, the inner diameter of each of the hollow submicron particles prepared from the predetermined material can be adjusted; if the difference between the hue indicated by the current spectral data and the hue of the target color is relatively small, the shell thickness of the shell (or also referred to as “layer thickness of the shell”) of each of the hollow submicron particles prepared from the predetermined material can be adjusted. With the above means, coarse or fine adjustment of hue can be achieved.

The method for adjusting the inner diameter of each of the submicron particles prepared from the predetermined material, for example, includes: adjusting the outer diameter of each of the submicron particles as a hard template (e.g., increasing the outer diameter of each of the submicron particles as a hard template), then covering a TiO₂ shell layer over the outer layer of the hard template, and finally etching away the hard template, so as to adjust the inner diameter of each of the TiO₂ hollow submicron particles.

Adjusting the shell thickness of each of the hollow submicron particles prepared from the predetermined material, for example, includes: keeping the outer diameter of each of the submicron particles as the hard template unchanged, then covering a TiO₂ shell layer over the outer layer of the hard template, controlling the reaction time for forming the shell layer to achieve the adjustment to the shell thickness of the TiO₂ hollow submicron particle, and finally etching away the hard template. For example, by prolonging the reaction time for forming the shell, the shell thickness of the TiO₂ submicron particle can be increased.

At block 1010, if the difference between the hue indicated by the spectral data and the hue threshold of the target color is less than the second threshold, it is determined that the spectral data meets a predetermined condition.

With the above means, the present disclosure can achieve free adjustment to hue.

Reference below will be made to FIG. 11 to describe a method 1100 for adjusting a ratio to a predetermined ratio according to embodiments of the present disclosure. FIG. 11 is a flowchart of a method 1100 for adjusting a ratio to a predetermined ratio according to embodiments of the present disclosure. It would be appreciated that the method 1100 may include additional actions not shown and/or skip some actions shown therein, and the scope of the present disclosure is not limited in the aspect.

At block 1102, submicron particles prepared from the predetermined material are put into a predetermined solution to generate a first submicron particle solution.

At block 1104, cuttlefish juice submicron particles are put into a predetermined solution to generate a second submicron particle solution.

At block 1106, a ratio of the first submicron particle solution to the second submicron particle solution is adjusted such that a ratio of the submicron particles prepared from the predetermined material to the cuttlefish juice submicron particles can be adjusted to a predetermined ratio.

The above descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The above described are only optional embodiments of the present disclosure, not constituting a limitation to the present disclosure. For those skilled in the art, lots of modifications and variations to the present disclosure are allowed. Within the spirit and scope of the present disclosure, any modifications, equivalent substitutions, improvements, and the like should all fall into the protection scope of the present disclosure.

I/We claim:

1. A method for preparing a colorant having a target color, comprising:
configuring submicron particles prepared from a predetermined material to have a predetermined size, wherein the predetermined size is associated with a predetermined hue;
adjusting a ratio of the submicron particles prepared from the predetermined material to cuttlefish juice submicron particles to a predetermined ratio, wherein the predetermined ratio is associated with a predetermined color saturation;
evaporating a predetermined solution mixed with the submicron particles prepared from the predetermined material and the cuttlefish juice submicron particles such that the submicron particles prepared from the predetermined material and the cuttlefish juice submicron particles can be self-assembled into an amorphous photonic crystal structure;
acquiring spectral data for reflected light generated by incident light irradiating the amorphous photonic crystal structure;
determining whether the spectral data meets a predetermined condition, wherein the predetermined condition is associated with the target color; and
responsive to determining that the spectral data does not meet the predetermined condition, adjusting at least one of the ratio or a size of each of the submicron particles prepared from the predetermined material, until the spectral data meets the predetermined condition to generate the colorant having the target color based on the amorphous photonic crystal structure.

2. The method of claim 1, wherein, responsive to determining that the spectral data does not meet the predetermined condition, adjusting at least one of the ratio or the size of each of the submicron particles prepared from the predetermined material comprises:
responsive to determining that a difference between a color saturation indicated by the spectral data and a saturation threshold of the target color is greater than or equal to a first threshold, adjusting the ratio of the submicron particles prepared from the predetermined material to the cuttlefish juice submicron particles;
responsive to determining a difference between a color saturation indicated by the spectral data and a saturation threshold of the target color is less than the first threshold, determining whether a difference between a hue indicated by the spectral data and a hue threshold of the target color is greater than or equal to a second threshold;
responsive to determining that the hue indicated by the spectral data and the hue threshold of the target color is greater than or equal to the second threshold, adjusting the size of each of the submicron particles prepared from the predetermined material; and
responsive to determining the difference between the hue indicted by the spectral data and the hue threshold of the target color is less than the second threshold, determining that the spectral data meets the predetermined condition.

3. The method of claim 2, wherein, responsive to determining that the hue indicated by the spectral data and the hue threshold of the target color is greater than or equal to the second threshold, adjusting the size of the submicron particles prepared from the predetermined material comprises:
responsive to determining that the difference between the hue indicated by the spectral data and the hue threshold of the target color is greater than or equal to a third threshold, adjusting an inner diameter of each of hollow nanosphere shells of the submicron particles prepared from the predetermined material; and
responsive to determining that the difference between the hue indicated by the spectral data and the hue threshold of the target color is greater than or equal to the second threshold and less than the third threshold, adjusting a layer thickness of each of the hollow nanosphere shells of the submicron particles prepared from the predetermined material.

4. The method of claim 1, wherein the nanosphere shells of the submicron particles prepared from the predetermined material each have an inner diameter between 170 nm and 250 nm and a layer thickness between 20 nm and 50 nm, and the predetermined material is an edible material.

5. The method of claim 1, wherein the predetermined material is titanium dioxide or silicon dioxide, the submicron particles prepared from the predetermined material are solid or hollow spheres, and the colorant is a food colorant, cosmetic colorant, or pharmaceutical label colorant.

6. The method of claim 1, wherein adjusting the ratio of the submicron particles prepared from the predetermined material to the cuttlefish juice submicron particles to the predetermined ratio comprises:
putting the submicron particles prepared form the predetermined material into a predetermined solution to generate a first submicron particle solution;
putting the cuttlefish juice submicron particles into the predetermined solution to generate a second submicron particle solution; and
adjusting a ratio of the first submicron particle solution to the second submicron particle solution such that the ratio of the submicron particles prepared from the predetermined material to the cuttlefish juice submicron reaches the predetermined ratio.

7. The method of claim 1, wherein evaporating the predetermined solution mixed with the submicron particles prepared from the predetermined material and the cuttlefish juice submicron particles such that the submicron particles prepared from the predetermined material and the cuttlefish juice submicron particles can be self-assembled into the amorphous photonic crystal structure, comprises:
applying to a target object the predetermined solution mixed with the submicron particles prepared from the predetermined material and the cuttlefish juice submicron particles;
baking or freezing the target object to evaporate or sublimate the predetermined solution such that the submicron particles prepared from the predetermined material and the cuttlefish juice submicron particles can be self-assembled into the amorphous photonic crystal structure on the target object, wherein a baking temperature is less than or equal to 250° C.

8. The method of claim 1, wherein evaporating the predetermined solution mixed with the submicron particles prepared from the predetermined material and the cuttlefish juice submicron particles such that the submicron particles prepared from the predetermined material and the cuttlefish juice submicron particles can be self-assembled into the amorphous photonic crystal structure, comprises:
leaving the predetermined solution mixed with the submicron particles prepared from the predetermined material and the cuttlefish juice submicron particles to stand, the predetermined solution being water; and
evaporating the predetermined solution such that the submicron particles prepared from the predetermined material and the cuttlefish juice submicron particles can be self-assembled into the amorphous photonic crystal structure.

9. A colorant having a target color, the colorant prepared with the method of claim 1.

10. The colorant of claim 9, wherein the colorant is a food colorant, cosmetic colorant or pharmaceutical label colorant.
